(19) United States
(12) Patent Application Publication
(10) Pub. No.: US 2013/0284540 A1
(43) Pub. Date: Oct. 31, 2013

(54) MECHANICAL MOTION SYSTEM FOR ENERGY GENERATION

(71) Applicant: Renato Ribeiro, Puerto Alegre (BR)

(72) Inventor: Renato Ribeiro, Puerto Alegre (BR)

(21) Appl. No.: 13/852,999

(22) Filed: Mar. 28, 2013

Related U.S. Application Data
(63) Continuation of application No. 13/848,006, filed on Mar. 20, 2013.
(60) Provisional application No. 61/618,451, filed on Mar. 30, 2012.

(30) Foreign Application Priority Data
Mar. 30, 2012 (BR) 10 2012 007288 2

(51) Int. Cl. F03G 3/06

(52) U.S. Cl. CPC F03G 3/06; F03G 7/10
USPC 185/29; 74/DIG. 9

(57) ABSTRACT

Objective—Create a mechanical system to manage the gravitational force exerted on a series of weights; with the ultimate goal of transferring this force to turn a shaft. The system consists of a fixed base and 2 types of mechanical modules. The modules are arranged side-by-side along a crankshaft. One module type consists of rods connected to a crankshaft. Two arms are connected to the fixed structure and to a third arm. All are connected to a central shaft by a connecting rod. A second type of module consists of a support arm for the weight connected to the central axis. The length of the support arm is variable. The arm is held in position by a pin which is pulled at the precise moment; altering the length of the arm. This shifts the center of gravity and drives the crankshaft. The altering of the arms' lengths is synchronized.

### RELATED APPLICATION

This application relates to and claims priority from U.S. Provisional Application 61/636,451 filed Mar. 30, 2012, entitled SYSTEM OF MECHANICAL MOTION FOR POWER GENERATION, still pending, and is a continuation-in-part of U.S. Utility application Ser. No. 13/848,006 filed Mar. 20, 2013, entitled MECHANICAL MOTION SYSTEM FOR ENERGY GENERATION still pending. The contents of these applications are incorporated by reference herein in their entirety.

### INITIAL CONSIDERATIONS

The present disclosure relates to continuous and perpetual mechanical motion for energy production exclusively powered by the force or energy of gravity.

### FIELD OF INVENTION

The present invention is in the area of energy production but focused on and with the objective of obtaining this generation by only using the energy of gravity. When we think of exclusively using force of gravity to power the system, and when this force is present at any place and at any time and is constant, we are not referring to perpetual motion that will work forever while the mechanical equipment that makes up the system lasts. This would be the greatest innovation of recent times. It would promote a huge change in the world that will be referred to before and after this invention.

### DESCRIPTION OF RELATED ARTS

For centuries the industrial development and global population growth have been demanding the availability of more energy. Formerly, energy was obtained from firewood and coal, which supplied the energy necessities of the world for a long period of time. For a long time we also had the use of windmills that were replaced by an easier and cheaper means at the time, which was oil and this way these sources were developed till present. We continue to burn firewood and coal and this developed into the burning of other types of wastes. When oil became expensive, the use of windmills returned and this also resulted in the use of solar energy. Recently we have the use of fats in general that are transformed into diesel. The continuous increasing need for energy is also forcing the development of other smaller sources of energy. Our field of invention is based on this history of energy, in search of new sources of energy.

In the last centuries thousands of attempts have been made to create a form of using gravity. Major values were invested with this purpose all over the world without obtaining results. For a long time in past centuries the English government offered a large amount as reward for whoever created the then called continuous motion.

### OBJECTIVE OF THE INVENTION

Therefore, the objective of the present invention is to create a system to produce energy as well as the equipment necessary only using the planet's gravity as source of energy. To achieve the objective above, we developed a conception of different types of motions made up of a crankshaft and mechanical bars making up assemblies. Furthermore, these assemblies were placed side by side. In this case there is a 45 degrees lag between them. The movements of each assembly are combined and synchronized. Finally, each assembly has a weight support bar. On this bar two arms are connected, which support the rail where a device moves being the weight itself. This bar is supported on the positive or neutral bars through mobile or fixed locks that are placed or removed at the appropriate time.

### DRAWINGS

FIGS. 1 and 1-A shows perspective views of an equipment completely built to incorporate an exemplary embodiment of the system according to the present invention;

FIGS. 2 and 2-A shows perspective views of an equipment completely built to incorporate an exemplary embodiment of the system according to the present invention;

FIGS. 3 and 3-A shows detailed views of the components of one of motion assemblies of the system according to the exemplary embodiment of the present invention (central shaft);

FIG. 4 shows a view which highlights the dimensions of the component parts of a model of the equipment that is being built now;

FIGS. 5 and 5-A shows perspective views of a double equipment that features two systems according to the exemplary embodiment of the present invention;

FIG. 6 shows a side view of a first motion assembly of the system according to the exemplary embodiment of the present invention (crankshaft at ZERO degrees, and locks);

FIG. 7 shows a side view of a second motion assembly of the system according to the exemplary embodiment of the present invention (crankshaft at 18°, and locks);

FIG. 8 shows a side view of a second motion assembly of the system according to the exemplary embodiment of the present invention (crankshaft at 45°, and locks);

FIG. 9 shows a side view of a second motion assembly of the system according to the exemplary embodiment of the present invention (crankshaft at 60°, and locks);

FIG. 10 shows a side view of a second motion assembly of the system according to the exemplary embodiment of the present invention (crankshaft at 126°, and locks);

FIG. 11 shows a side view of a second motion assembly of the system according to the exemplary embodiment of the present invention (crankshaft at 199°, and locks);

FIG. 12 shows a side view of a second motion assembly of the system according to the exemplary embodiment of the present invention (crankshaft at 243°, and locks);

FIG. 13 shows a detailed view of what a lock and a fixed lock is;

FIG. 14 shows a view in technical lines of the assembly shown in FIG. 13;

FIG. 15 shows a detail of the central shaft, especially the bars are independent of one another;

FIG. 16 shows an angles formed by the upper arms and without limiting the rail.

### LIST OF NUMERICAL REFERENCES USED IN THE DRAWINGS

| Component | Reference number |
|---|---|
| Motion assemblies or arrangements | 1 |
| Crankshaft | 2 |
| Crankshaft bearing | 3 |
| Support structure | 4 |
| Rod | 5 |
| Positive force bar | 6 |
| Positive force bar | 7 |
| Fixed lock | 8 |
| Movable lock | 9 |
| Fixed lock | 10 |
| Neutral bar | 11 |
| Central shaft | 12 |
| Weight support bar | 13 |
| Telescopic arm | 14 |
| Armlock rod | 15 |
| Tilt control arm | 16 |
| Rail weight support arm | 17 |
| Rail weight | 18 |
| Movable weight | 19 |
| Arc-locks | 20 |
| Angle on the weight assembly | 21 |
| Machines of the double equipment | M1, M2 |

### DETAILED DESCRIPTION OF THE INVENTION

The present equipment is built exclusively mechanical, using common material existing in the market, such as a support structure constructed of steel beams, one crankshaft, metal bars connected with each other through bearings or supported on each other and a weight made with steel plates.

It was planned and designed to assemble these parts with an arrangement forming assemblies and placing these assemblies side by side connected to each arm of the crankshaft.

This arrangement was designed with two specific and fundamental functions. The first one is to enable the transfer of energy from the gravity force existing over the system of the weight support bar through the positive or neutral bars and the central shaft, going to the crank arm generating a torque on it axis.

The second function is to enable, by placing or removal the bars on the arch support bars, or the telescopic arm and on the armlock rod which is chosen in which bar will be supported the weight support bar. Also enable to choose the moment and the time that this support remains effective.

The value of the gravitational force existent over the weight support bar and its whole assembly, when they are supported on the neutral bar, is always the same, independently where the point of the gravity center of the assembly comprising the weight support are. This weight will always have equal strength as if the weight system gravity center were in the central axis. Clarifying, whenever the system weight is supported on either side of the neutral bar, it will generate the same force on the central axis as though the system was supported on the same central axis.

The value of the force of gravity over the weight support bar system, when it is supported in one of the positive bars or in the rod, is added or increased by a proportional value between the length of the bar that is positively supported and the length of the weight support bar which exists between the central axis and the point on the weight supporting bar which is the center of gravity of the weight system. This measure varies each time, therefore the additional strength varies each time.

In this presentation, the choice of the position that each lock and the time it becomes effective is the same of the model-machine that I am building, one in Porto Alegre—Brazil, halfway through mounting, and another one in Gilman, Ill.—USA, where now the building is being constructed and the mounting should begin on July 2013. The size of the machine and the length of bars and arms and everything in general that we presented in this application, is equal to the model that is being built.

Finally, this machine, when its construction is complete, should be locked. When unlocked, the crankshaft will turn, and keep turning forever.

The presented equipment is built exclusively mechanical, using common material existing in the market. We use beams and angle brackets, cut and rolled steel plates, worked to make up isolated assemblies, placed side by side to work in sequence.

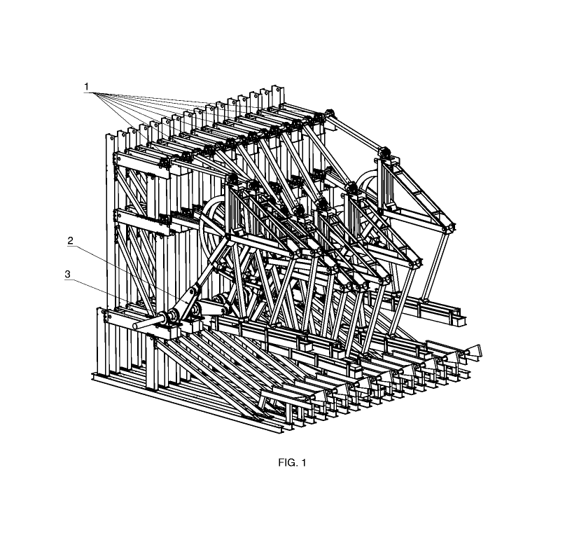

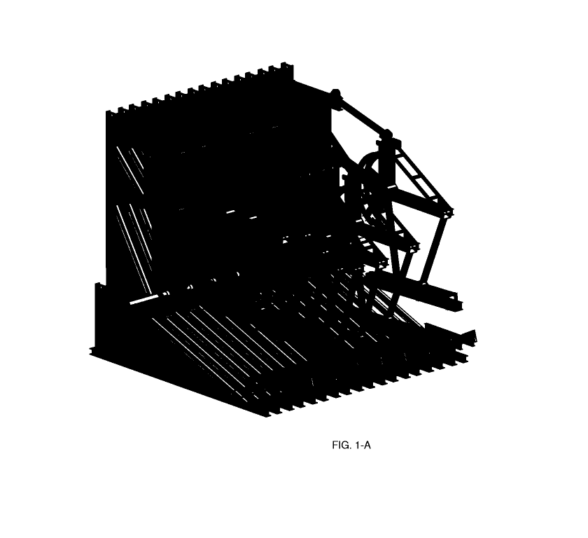

The invention consists in the conception and creation of an assembly where there are bars with positive force and a bar with neutral force. Besides these bars there is another bar over which the weight is placed. This bar is connected to the system made up of an arc where the locks are placed. These locks have the purpose and objective of connecting the weight bar with one of the other four bars in the convenient position and also in the suitable time to enable the use of the force of gravity. To achieve this objective, I built a prototype machine where I conducted these force tests. I was able to prove the existence of other forces besides gravity and I could collect this force and make it available by means of a torque on the crankshaft shaft. It all depends on the length of the bars and on which locks the weight support bar is supported. I will describe it further. FIG. 1 shows the complete assembly of the force testing equipment, where I could prove the existence of a force other than gravity, and could capture this force and make it available through a torque on the crankshaft. I am now building two new equipments, bigger in size, one in Porto Alegre—Brasil, at avenida Pátria, 195 and the other in Gilmam, Ill.—United States, at the industrial plant of Incobrasa Ltda. They will be demonstration models and will each produce about 30 KW. These equipments do not produce any type of pollution, noise or heat.

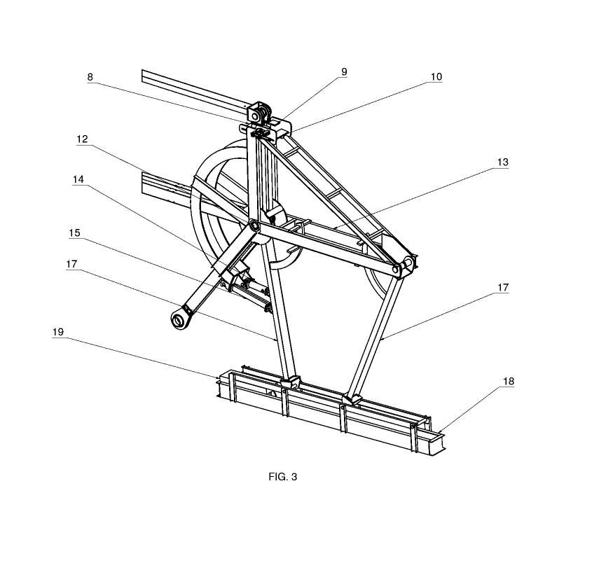

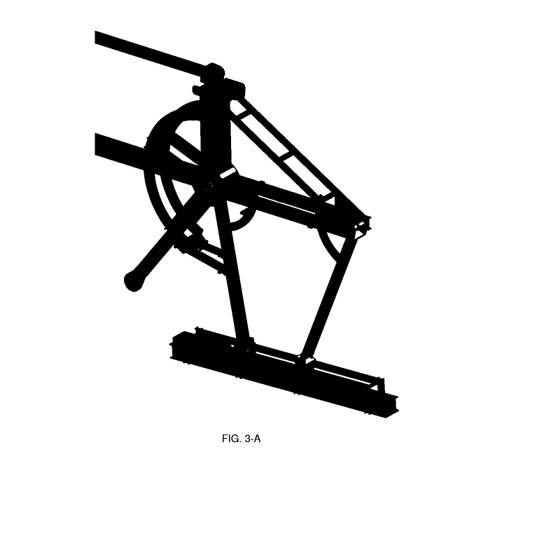

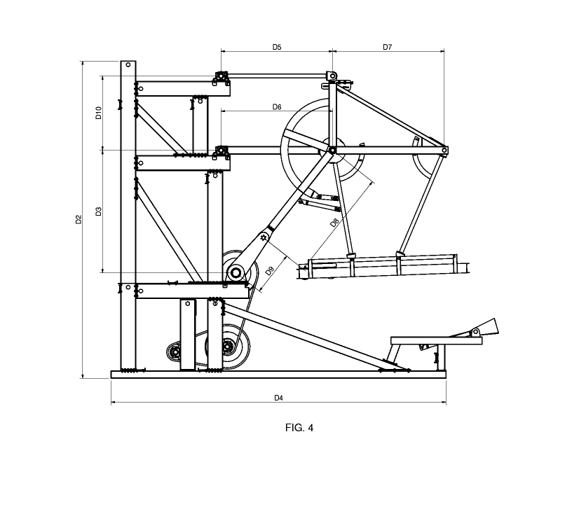

FIGS. 4 and 5 show the dimensions of the components of the equipment according to the illustrative concretization of the present invention, which is also the equipment that is now being built. However, it must be understood that these dimensions may be changed to achieve higher yields, according to the necessities of the design to be developed.

The table below shows the dimensions highlighted in the figures.

| | Dimension | Dimension |
|---|---|---|
| Component | reference | (mm) |
| Support structure 2 (length) | D1 | 17337 |
| Support structure 2 (height) | D2 | 8542 |
| Support structure 2 (height crankshaft support/ | D3 | 3298 |
| weight bar support) | | |
| Support structure 2 (width) | D4 | 9000 |
| Positive bars 4, 5 | D5/D6 | 3000 |
| Weight support bar 3 | D7 | 750 |
| Positive bar 6 | D8 | 3000 |
| Arm 12 of crankshaft 11 | D9 | 1200 |
| Neutral bar 7 | D10 | 2000 |

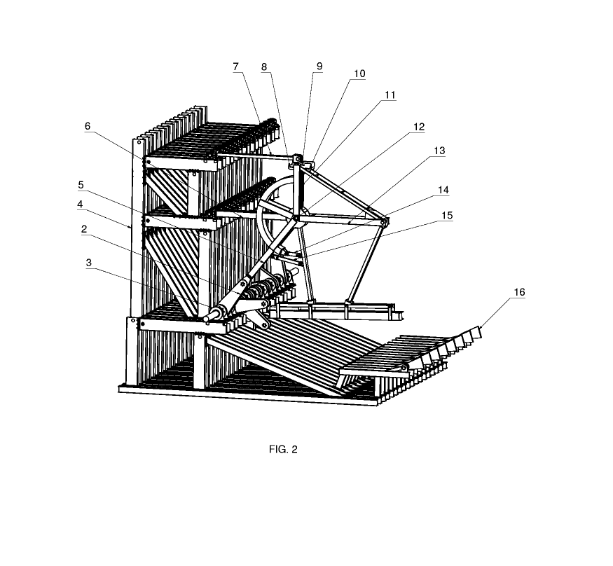

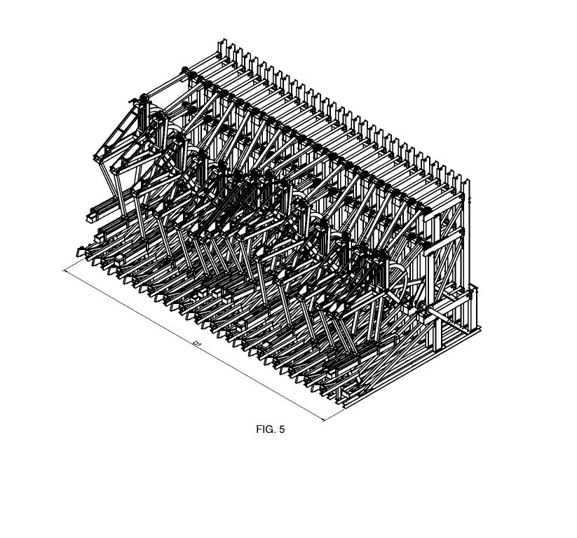

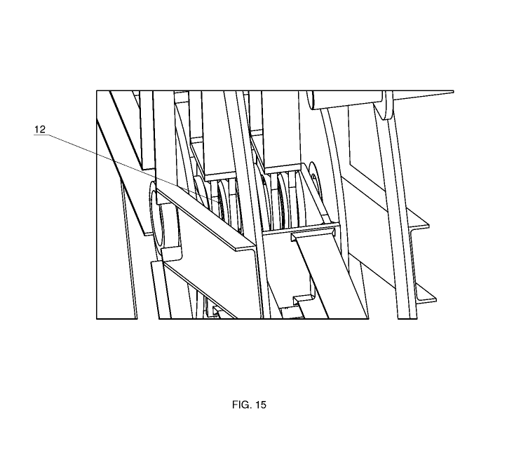

We are going to nominate angle ZERO, the movement initial point that we are going to show, and the FIGS. 2 and 6 show the crankshaft arm aligned to the positive bar called rod. From this point on, the movement will be clockwise. It was named the bar 6 as positive bar and the bar 5 as rod which is also a positive bar. These two bars, the first connected to the central bearing and the second connected to the crankshaft arm, and both connected to the central shaft, they form a triangle that controls all the machine motion while the crankshaft is spun. These two bars are connected independently to the central shaft through bearings as shown in FIG. 15. Bar 7 is also named positive bar because it follows the movement of the positive bar 6. This bar is connected to the top bearing and to the bar named neutral 11, being the latter connected to the central shaft. The connection is also through bearings and independent of the other bars. It forms then a rectangle across the top of the triangle, with one particular characteristic, which is why it is named neutral bar. At angle zero, we can see in FIGS. 2 and 6 that this so-called neutral bar 11 is exactly on the upright position and remains on this upright position throughout the movement of rotation of the crankshaft. These parts constitute, together with the crankshaft, the movement system of the equipment and we point out that they are independently connected to the central shaft, as shown in FIG. 15, thus they can freely move on bearings that are on the central shaft.

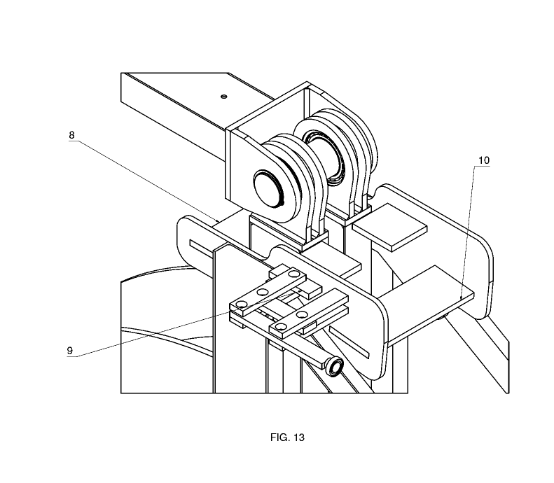

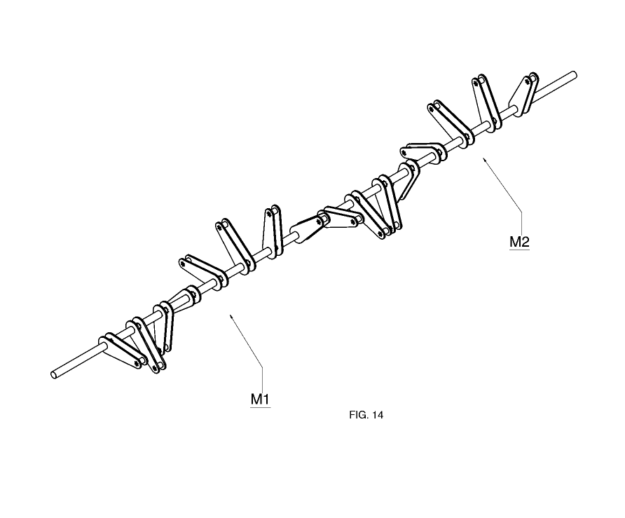

We also have a second system formed by a set of parts controlled by what we named weight support bar 13 shown in FIGS. 2 and 6. This bar is connected to the central shaft on the outside and independently of the other bars. This assembly is formed by the arc-locks support 20, which is rigidly connected to the central shaft and the weight support bar, rotating around the central shaft together with the weight support bar. Also connected to this rigid system, there are the locks of the neutral, as shown in FIG. 2, positions 8, 9, and 10. The locks no. 8 and no. 10 are fixed, i.e., they do not move during the movement. The lock no. 9, which is named movable lock, is removed and placed during movement as shown in FIG. 13. A mini-system which is triggered as it goes by a rail fixed to the structure moves this bar at the right time and for the right time the lock must remain connected or disconnected. Two arms named rail weight support arms 17 hung on the weight support bar 13, and connected to them is the rail weight 18 itself, and the device which is the weight 19 itself, which moves from one side to the other. It is also shown the telescopic arm 14, which connects the arc-locks to the rail weight support arm. This telescopic arm is also a movable lock for it works in two positions. Likewise, the arm lock rod 15 is also a movable lock. Both are triggered by a mini system or device when going through a rail fixed to the equipment structure.

Therefore, throughout this second system, comprising everything which is connected to the weight support bar and also to the central shaft has its own movement that occurs concurrently with the movement of the crankshaft. This system is always connected to one of the crankshaft bars through the locks. Thus, when planning the movement of the equipment, it is possible to choose to which crankshaft bars to connect the system driven by the weight support bar, as well as when and how long it is supported on either of the bars. All synchronously.

Thus the gravity force that exists throughout the assembly and system formed by the weight support bar is transferred, i.e., it transits inside the equipment through the central shaft to which it is fixed and to the bar on which it is supported. Thus, the force of gravity exerted on the assembly comprising the weight support bar reaches the crankshaft arm in different ways during the movement. This choice of paths is a fundamental part of the invention.

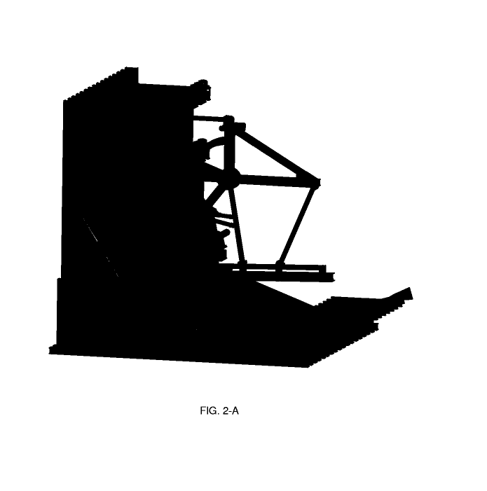

The arrangement shown in FIGS. 1, 2, 3 and 4 involving a support structure, a crankshaft, an assembly of interconnected arms, on the support structure and on the crankshaft and yet the assembly driven by the weight support bar which was specially designed and created with the objective and purpose of making it possible to work and manage the effects of the force of gravity that exists on the entire assembly and especially the assembly driven by the weight support bar. By choosing the radius of the crankshaft, the length of the arms and the angles, I am mounting a mechanical system that allows me to manage how the effects of gravity occur. This arrangement then has the specific function of making it possible to choose how the force of gravity will transmit piece by piece to the crankshaft. It also allows me to choose through the placement or removal of locks where I support the weight support bar and the weight itself, which can be on the positive bar 6, positive bar 5 or on the neutral bar 11. The function of removing and placing the locks on the convenient bar and at the convenient time is of extreme important to manage the force of gravity. Also, when I choose at which crankshaft angles the weight support bar is supported, that is, how long they remain supported on one or another bar, I am managing the force of gravity existing on the entire assembly and especially yet the assembly driven by the weight support bar.

A fundamental part of the invention is the arrangement that was designed and created to enable handling the force of gravity existing on the weight support bar and the weight itself. The change in proportion of dimensions between each piece of the arrangement can improve the yield of the invention, but the important thing is the formation of the arrangement that creates the possibility of choosing how to transfer the force of gravity that exists on the weight support arm and on the weight to the crankshaft.

Another fundamental part is the function of the locks that can be placed and removed to choose the exact moment and period when they should be supported on one or another positive or neutral bar.

Shown below is the influence of the forces of gravity when the weight bar is supported on each one of the positive or neutral bars.

1—When the weight bar and the weight itself are supported on the neutral bar 11 through the lock that is placed on the support arc of the locks, the force of gravity exerted on the weight will always be the same and will have the same value anywhere on the support bar where the weight is hanged from. Therefore, the value of the force of gravity that the weight support bar transfers to the central shaft is exactly the same. Hence, everything occurs as if the weight was hanging from the central shaft, even if it is really hanging from the central shaft or from the tip of the weight support bar as shown in the drawing. At any point of the assembly motion, that is, turning the crankshaft 360 degrees, the weight support bar will remain in the horizontal position. This is because the neutral bar always remains in the same position. When connected to this bar, the weight support bar consequently remains in the horizontal position. With all the eight weight bars supported on the neutral bar, the equipment will be balanced. It moves freely with any impulse and stops at any point.

2—When the weight support bar and all its weight are supported on the positive bar 6 through the lock placed on the support arc locks, the force of gravity exerted on the bar and weight that transfers to the central shaft have an additional force, in other words, a proportional value between the length of the positive bar 6 and the length of the assembly support bar that lies between the central shaft and where is the center of gravity of the assembly of the weight support bar. Therefore, always when the support bar 13 remains supported in the positive bar 6, it will tilt in the same angle and direction of the positive bar 6. It is worth emphasizing that the force of gravity existing on the central shaft and its addition is transmitted to the crankshaft through the blue positive bar and depending on the angle of the crankshaft arm, the force will be proportional to the this angle. Therefore, there is a force variation for low and high for each position existing between the crankshaft arm and the positive bar 5.

3—When the weight bar and the weight itself are supported on the positive bar 5 and also named rod, there is a much more complex and complicated situation in comparison to the support on the neutral bar 11 or positive bar 6. Regarding the force of gravity existing on the weight support bar and whole, this force will also have an increase or an additional force when this force is transferred to the central shaft, in the same way it occurs and has already been described when the support is on the positive bar 6. That is, both on the positive bar 6 and the positive bar 5, the force of gravity transmitted to the central shaft is proportional to the length of the bars. However, when the force of the central shaft is transmitted to the crankshaft arm through the positive bar 5, a very complex and complicated formation of forces occurs, as already mentioned.

When the weight support bar and its whole assembly are connected to the rod, which is also positive bar 5, the forces may be positive or negative in comparison with the force that would exist if the support were on the neutral bar.

### Weight Support Bar and Related Parts

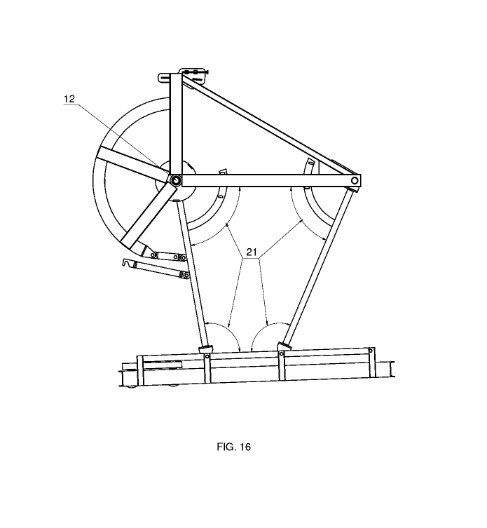

This system triggered by the weight support bar is of paramount importance for the invention and therefore it is important to know its characteristics. The entire assembly is supported on bearings on the central shaft independently from the other crankshaft system which is also connected to the central shaft. Besides the central shaft, this assembly will always have one of its locks connected to or supported on the neutral bar 11, the positive bar 6, or the other positive bar 5 also named rod. Then there is also the possibility to choose where and when this assembly remains supported and transmitting the force of gravity that exists on it. Yet during the movement, this assembly alters its center of gravity. Firstly, the entire rail, with the weight device shifts to the right, pushed by the rod, altering the angles indicated in FIG. 16, position 21. After this movement that shifts the center of gravity to the right, the weight device begins to shift to the right, starting a further shift of the center of gravity further to the right.

The construction design of this assembly will consider the ratio of the weights of the materials used and also the ratio of the weight of the device and the rest of the assembly so that the center of gravity is in the proper position.

### Detailed Operation of the Invention

FIG. 6 shows the weight support bar on the horizontal position, the crankshaft at ZERO degrees, which represents the crankshaft arm aligned with the positive bar 5. At this angle zero degrees, the weight support bar is supported by the movable lock of the neutral bar 11. The armlock rod 15 and the telescopic arm 14 are locked. At this angle zero degrees, movable lock 9 of the neutral bar is removed and the movement starts triggered by the crankshaft arms, which are at zero, 45, 90, and 225 degrees, being outside of the neutral bar support, i.e., are not supported on the neutral bar 11. The other four crankshaft arms are supported on the neutral bar 11 at the beginning of this movement.

The movement from zero to 18 degrees of the arm that has started at zero degrees, the weight system is then supported by the rod or positive bar 5, and the telescopic arm 14. The weight support bar 13 tilts up and is supported by the fixed lock 10 of the neutral bar 11. It's worth noting that at the moment of this movement, the weight support bar tilts up, the entire weight of the rail 18 and movable device 19, have shifted to the right.

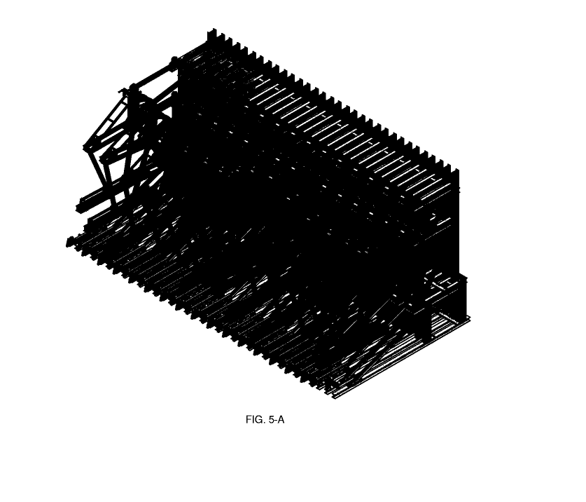

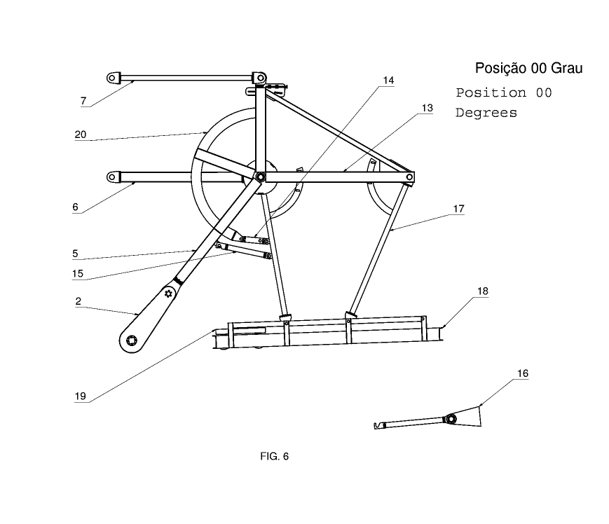

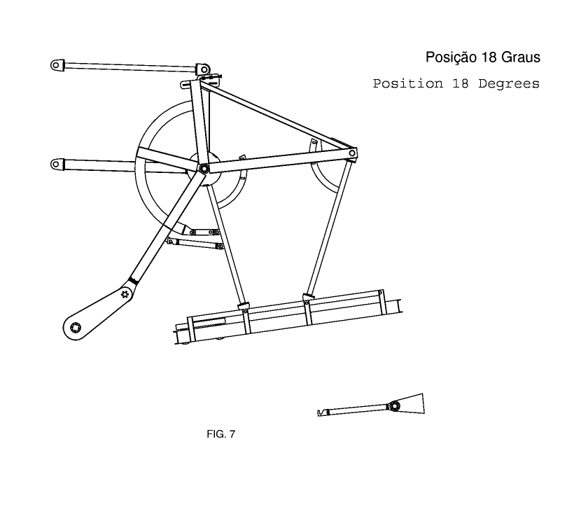

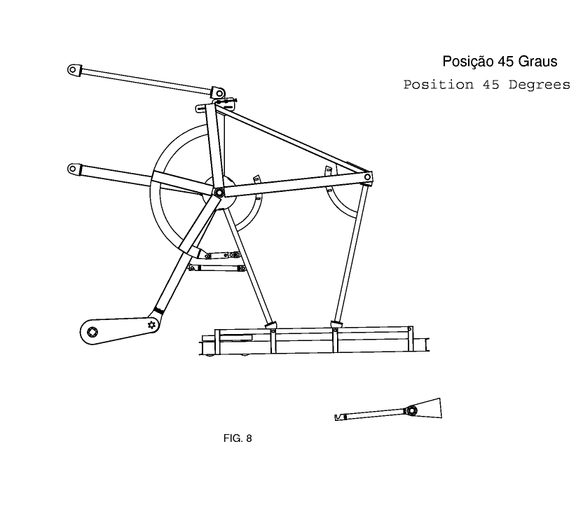

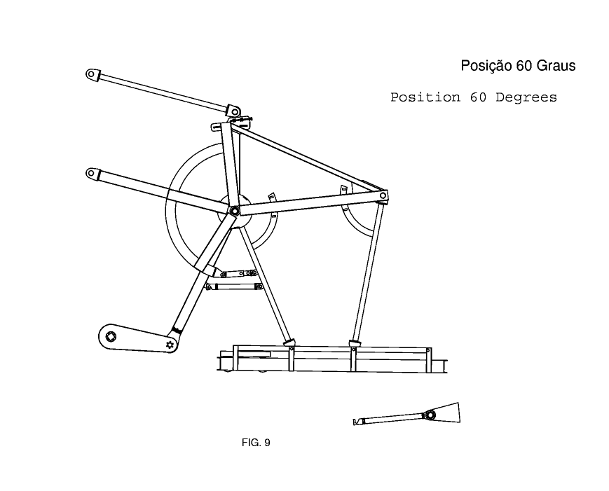

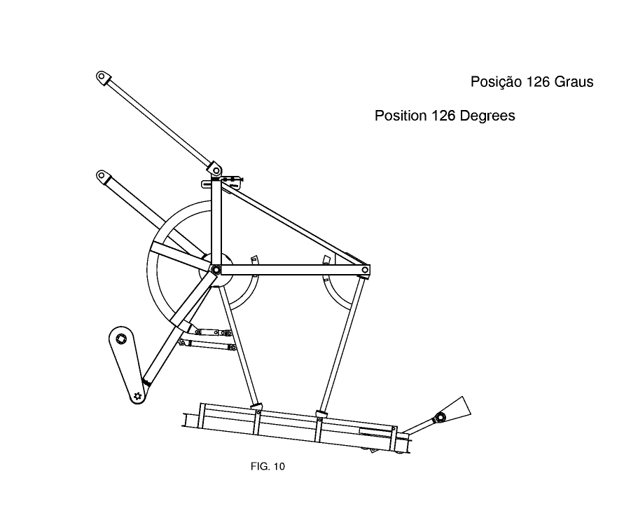

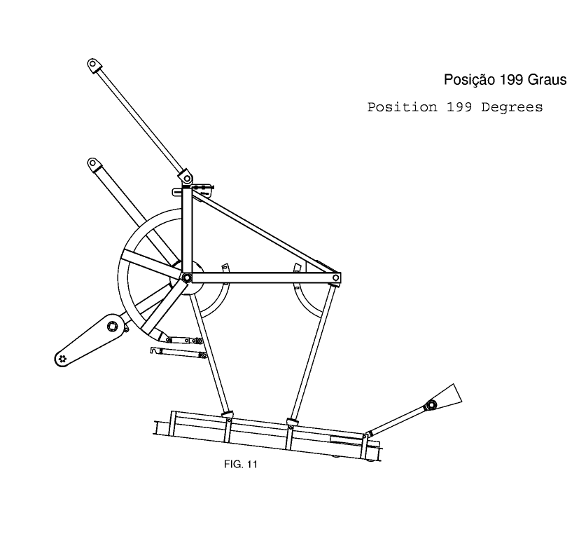

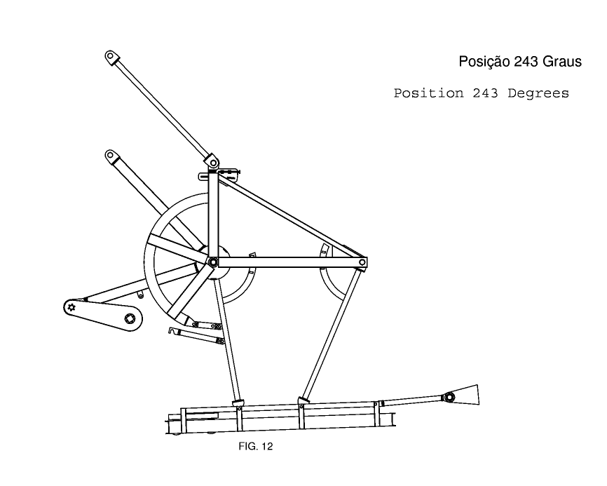

When the assembly is supported by the fixed lock 10 of the neutral bar 11, the lock of the telescopic arm is released 14 and the movement continues to angle 60 degrees driven yet by armlock rod 15, locked on the rod 5. During this movement the angles shown in FIG. 16, position 21, shift and the weight rail together with the weight device shift to the right, thus the center of gravity of the assembly also shifts to the right. At angle 60 degrees, the weight device starts shifting to the right, thus shifting again the center of gravity of the weight system to the right at angle 126 degrees. FIG. 6 depicts a crankshaft arm at angle zero degrees. FIG. 7 depicts the crankshaft arm at angle 18 degrees, and FIG. 8 at angle 45 degrees. FIG. 9 depicts the crankshaft arm at angle 60 degrees and then starts the shifting of the weight device to the right. When the arm of the crankshaft is passing through angle 75 degrees, the weight device will already be on the right side of the rail, and the center of gravity of the system of the weight support bar will have reached its maximum position to the right and will continue until angle 126 degrees as shown in FIG. 10. At this angle the system of the weight support bar is supported by the fixed lock 8, of the neutral bar 11, and remains supported on this lock until angle zero degree, when the cycle is completed. During this course, when the arm is at angle 199 degrees, the tilt control arm 16 is connected, as shown in FIGS. 2, 6 and especially FIG. 11. Is remains connected until the crankshaft arm shifts to angle 243 degrees, when the rail of the weight is back to the angle it started its course, at angle zero degrees and the weight has shifted to the left. At angle 243 degrees tilt control arm is disconnected and movable lock 9 of the neutral bar and the lock of the telescopic arm 14 are replaced.

It is worth noting that the pitch of the equipment is 45 degrees, so every 45 degrees of course of the arm that starts at angle zero degrees, other arm reaches angle zero degrees and starts its cycle. Once completed the installation of the equipment, the additional force existing in the crankshaft torque due to the motion of the system that controls weight and of the locks that support it, the crankshaft will move permanently, stopping only if the machine is locked. This movement will be forever.

Another worth noting thing is that during the 45 degrees cycle, the intensity of torque will vary. Thus, each degree has an intensity of torque and to better stabilize such torque, I am building a dual machine, namely two identical machines connected to each other by the crankshaft, a 22.5 degrees gap between them. Thus, the intensity of the torque or force available from the crankshaft is much more steady. FIG. 5 depicts, a set of two equipments. In the shaft that connects them there is a gear that transmits power to a generator.

The industrial application of this equipment is broad and unlimited. The entire world seeks a source of producing energy without pollutants or heat that can destroy the atmosphere. A few days ago, the US president mentioned in his inaugural speech that the US will have the main goal of producing energy with renewable resources. He still has no idea that we will be able to produce energy with resources eternally available at any quantity, at any place or time, without noise, pollution or heat. This invention will certainly promote an industrial and world revolution in the coming decades.

1: Mechanical motion system for energy generation characterized by be powered solely by force of gravity or energy, comprising an arrangement designed and built with a specific function to allow to handle the force of gravity in the system controlled by the weight support bar (13), comprising the arc-locks (20) the rail support arms (17), the weight of the rail (18) and the drive of the movable weight (19). This system relies on central axis (12) transfers energy to the bar on which are the lock and this in turn to the arm of the crankshaft generating a torque on the axis of the crankshaft. During movement, it varies the bars that are used, being a specific time in each selected bars and reaching the force of gravity axis as a torque.

2: Mechanical motion system for energy generation according to claim 1, characterized by assembling side by side assemblies shown in FIG. 1, in a number determined by the pitch chosen for the crank arms, and these arms crankshaft receive a positive impulse bar or rod (5) which is connected to the crankshaft axis and central (12) which, in turn, receives the impulse of a system comprising the arrangement of lower support bar weight (13).

3: Mechanical motion system for energy generation according to claim 1, characterized by the system of locks, according to FIG. 13 which are driven or withdrawn in appropriate time during the movement of the crankshaft and the whole arrangement, and these locks has the specific function of determining the path of the force that the system will support bar weight (13) to the axis of the crankshaft, and depending upon the choice of where these supporting bars, FIG. 2, which may be positive on the bar (6), the rod (5), the telescopic arm (14), the arm the locking rod (15) and neutral bar (8, 9 and 10), and how much time remains supported on each of these bolts, for a movement of 360 degrees of the crankshaft, it will generate a change in intensity of the gravity force that arrives the axis of the crankshaft where we provide the torque and differentiation of forces will be in proportion to the length of the bar that is positively supported in the lock and length of the support bar weight between the central axis and the center of gravity of the weight system.

4: Mechanical motion system for energy generation according to claim 1, 2 or 3, characterized by the fact that the arrangements mentioned above have angles formed between the crank arm and the bar positive or rod (5) with positive rod (6), the neutral bar (11), a weight support bar (13).

5: Mechanical motion system for energy generation according to claim 1, 2, or 3, characterized by the fact that changes in the dimension of the machine for more, such as crankshaft (11) radius, the length of the arms, the size of the weights will increase or decrease the additional power, while the measures presented solely for the model construction and for better understanding of this application.

6: Mechanical motion system for energy generation according to claim 4, characterized by the fact that changes in the dimension of the machine for more, such as crankshaft (11) radius, the length of the arms, the size of the weights will increase or decrease the additional power, while the measures presented solely for the model construction and for better understanding of this application.
